(19) United States
(12) Patent Application Publication
(10) Pub. No.: US 2026/0221806 A1
(43) Pub. Date: Jul. 30, 2026

(54) NON-CONTACT ELECTRIC POWER SUPPLY DEVICE

(71) Applicant: HOSIDEN CORPORATION, Osaka (JP)

(72) Inventor: Kenji MIKI, Osaka (JP)

(21) Appl. No.: 19/453,097

(22) Filed: Jan. 20, 2026

(30) Foreign Application Priority Data
Jan. 24, 2025 (JP) 2025-010894

(51) Int. Cl. H02J 50/00; H02J 50/10; H02J 50/70; H02J 50/80; H02J 50/90

(52) U.S. Cl. CPC H02J 50/005; H02J 50/10; H02J 50/70; H02J 50/80; H02J 50/90

(57) ABSTRACT

A non-contact electric power supply device for supplying electric power contactlessly to an electric power supply target includes: a cover with a placement face on which to place the electric power supply target; a casing joined to the cover and defining a container space together with the cover an electric power supply coil unit contained in the container space, oriented parallel to the placement face, and including a coil configured to, in response to receiving electric power, generate a magnetic field for supplying electric power to the electric power supply target on the placement face; a first substrate contained in the container space, disposed opposite to the placement face across the electric power supply coil unit, and configured to supply electric power to the coil; a second substrate contained in the container space, disposed between the placement face and the electric power supply coil unit, and configured to attenuate noise in the magnetic field; and an elastic connector element disposed between the first substrate and the second substrate and electrically connecting the first substrate to the second substrate.

### CROSS REFERENCE TO RELATED APPLICATION

This application is based on and claims priority under 35 U.S.C. Section 119 to Japanese Patent Application No. 2025-010894 filed on Jan. 24, 2025, the entire content of which is incorporated herein by reference.

### TECHNICAL FIELD

This disclosure relates to a non-contact electric power supply device.

### RELATED ART

A known non-contact electric power supply device charges an electric power supply target contactlessly. US2019/0173187A1 discloses a device for combined transmission, the device being configured for contactless signal transmission as well as contactless energy transmission, that is, contactless supply of electric power with use of a magnetic field generated by conduction of electric current through a coil. The device includes between the coil and an electric power supply target a circuit board with a first part structure and a second part structure each functioning as an antenna. The first part structure receives a signal voltage. The second part structure has a ground potential and functions to attenuate the magnetic field generated by the coil.

### SUMMARY

The device disclosed in US2019/0173187A1 is configured such that the first part structure receives a signal through a coaxial cable. This suggests that the second part structure is also connected to a ground potential through a coaxial cable. A person may connect a coaxial cable to the circuit board by roughly one of two methods: (i) directly soldering the center conductor and the ground conductor of the coaxial cable to the circuit board or (ii) attaching a coaxial connector to an end of the coaxial cable, mounting a paired coaxial connector on the circuit board, and fitting the two coaxial connectors with each other. Either method, however, requires man-hours for the connection and costs of components such as the coaxial cable. This leads to an increase in the cost of the device, leaving room for improvement.

The above circumstances have led to a demand for a non-contact electric power supply device including two substrates electrically connected to each other by a simple method.

A non-contact electric power supply device as an embodiment of this disclosure is a non-contact electric power supply device for supplying electric power contactlessly to an electric power supply target including a secondary battery, the non-contact electric power supply device including: a cover with a placement face on which to place the electric power supply target; a casing joined to the cover and defining a container space together with the cover; an electric power supply coil unit contained at least partially in the container space, oriented parallel to the placement face, and including a coil configured to, in response to receiving electric power, generate a magnetic field for supplying electric power to the electric power supply target on the placement face; a first substrate contained at least partially in the container space, disposed opposite to the placement face across the electric power supply coil unit, and configured to supply electric power to the coil; a second substrate contained at least partially in the container space, disposed between the placement face and the electric power supply coil unit, and configured to attenuate noise in the magnetic field; and an elastic connector element disposed between the first substrate and the second substrate and electrically connecting the first substrate to the second substrate.

The non-contact electric power supply device as this embodiment includes a connector element elastically deformed between the first and second substrates and applying restoring force (contact force) to the first and second substrates. This allows the first and second substrates to be electrically connected to each other easily and stably in a simple method. This configuration allows a person to check whether the connector element is elastically deformed to determine whether the first and second substrates are electrically connected to each other.

The non-contact electric power supply device as this embodiment includes a second substrate provided with a circuit pattern for attenuating noise in a magnetic field generated by the coil of the electric power supply coil unit. This reduces extraneous emission from the electric power supply coil unit to prevent noise from affecting the electric power supply target and surrounding devices. This in turn allows the non-contact electric power supply device to have good electromagnetic interference characteristics. The casing and the cover define a container space therebetween for protecting the first substrate, the second substrate, and the electric power supply coil unit from outside dust or the like.

A non-contact electric power supply device as another embodiment of this disclosure is configured such that the cover includes a support in a form of a bar extending perpendicularly to a face of the second substrate through the second substrate, and the connector element is a compression coil spring fitted around the support and elastically deformed between the first substrate and the second substrate to electrically connect the first substrate to the second substrate.

The non-contact electric power supply device as this embodiment includes a compression coil spring as the elastic connector element. Fitting the compression coil spring around the support of the cover allows the compression coil spring to be positioned easily and prevents the compression coil spring from becoming easily displaced due to its elastic deformation. The compression coil spring is in contact with the first and second substrates due to its restoring force generated by the elastic deformation. This establishes stable electric connection between the first and second substrates in a simple method.

A non-contact electric power supply device as another embodiment of this disclosure further includes: a first shield casing contained at least partially in the container space and disposed between the electric power supply coil unit and the first substrate.

The non-contact electric power supply device as this embodiment includes a first shield casing between the electric power supply coil unit and the first substrate. The first shield casing at least partially blocks the first substrate to more efficiently block noise from the first substrate. This prevents such noise from overlapping a magnetic field generated by the coil or affecting an electric power supply target and surrounding devices.

A non-contact electric power supply device as another embodiment of this disclosure further includes: a second shield casing disposed opposite to the electric power supply coil unit across the first substrate.

The non-contact electric power supply device as this embodiment includes a second shield casing at least partially blocking that face of the first substrate which is opposite to the electric power supply coil unit to prevent noise from the first substrate from adversely affecting surrounding devices.

A non-contact electric power supply device as another embodiment of this disclosure is configured such that the second shield casing includes a support in a form of a bar extending perpendicularly to a face of the first substrate through the first substrate, and the connector element is a compression coil spring fitted around the support and elastically deformed between the first substrate and the second substrate to electrically connect the first substrate to the second substrate.

The non-contact electric power supply device as this embodiment includes a compression coil spring as the elastic connector element. Fitting the compression coil spring around the support of the second shield casing allows the compression coil spring to be positioned easily and prevents the compression coil spring from becoming easily displaced due to its elastic deformation. The compression coil spring is in contact with the first and second substrates due to its restoring force generated by the elastic deformation. This establishes stable electric connection between the first and second substrates in a simple method.

A non-contact electric power supply device as another embodiment of this disclosure is configured such that the casing has a shielding function.

The non-contact electric power supply device as this embodiment includes a casing with a shielding function. This eliminates the need for an element with a shielding function other than the casing, and allows the non-contact electric power supply device to be inexpensive and lightweight.

A non-contact electric power supply device as another embodiment of this disclosure is configured such that the casing includes a support in a form of a bar extending perpendicularly to a face of the first substrate through the first substrate, and the connector element is a compression coil spring fitted around the support and elastically deformed between the first substrate and the second substrate to electrically connect the first substrate to the second substrate.

The non-contact electric power supply device as this embodiment includes a compression coil spring as the elastic connector element. Fitting the compression coil spring around the support of the casing allows the compression coil spring to be positioned easily and prevents the compression coil spring from becoming easily displaced due to its elastic deformation. The compression coil spring is in contact with the first and second substrates due to its restoring force generated by the elastic deformation. This establishes stable electric connection between the first and second substrates in a simple method.

A non-contact electric power supply device as another embodiment of this disclosure further includes: a communication antenna for contactless signal communication with the electric power supply target.

The non-contact electric power supply device as this embodiment includes a communication antenna for contactless signal communication with an electric power supply target. This allows the non-contact electric power supply device to start or stop supplying electric power to the electric power supply target on the basis of the result of the communication.

### BRIEF DESCRIPTION OF DRAWINGS

FIG. 1 provides front and back perspective views of a non-contact electric power supply device as an embodiment.

FIG. 2 is an exploded perspective view of a non-contact electric power supply device.

FIG. 3 is an exploded perspective view of a non-contact electric power supply device.

FIG. 4 is a cross-sectional view of the non-contact electric power supply device in FIG. 1 taken along line IV-IV.

FIG. 5 is an enlarged cross-sectional view of a portion of a non-contact electric power supply device as another embodiment which portion is around a support.

FIG. 6 is an enlarged cross-sectional view of a portion of a non-contact electric power supply device as another embodiment which portion is around a support.

### DESCRIPTION OF EMBODIMENTS

The description below deals in detail with non-contact electric power supply devices as embodiments of this disclosure with reference to drawings. The embodiments described below are merely example non-contact electric power supply devices; this disclosure is not limited to the embodiments. The non-contact electric power supply device according to this disclosure may be embodied variously without departing from the scope of this disclosure.

### Configuration of Non-Contact Electric Power Supply Device

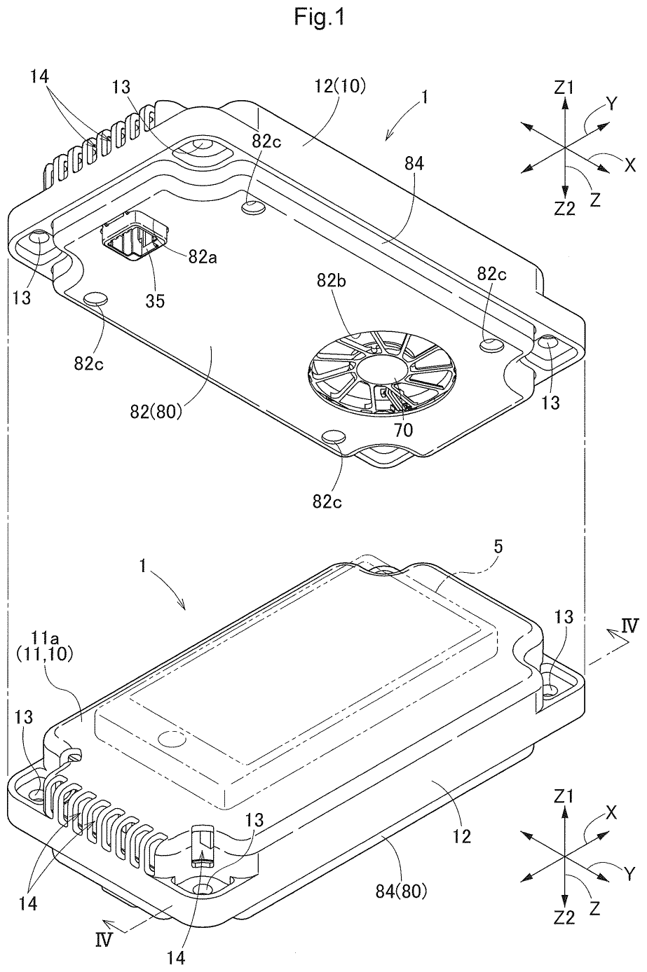

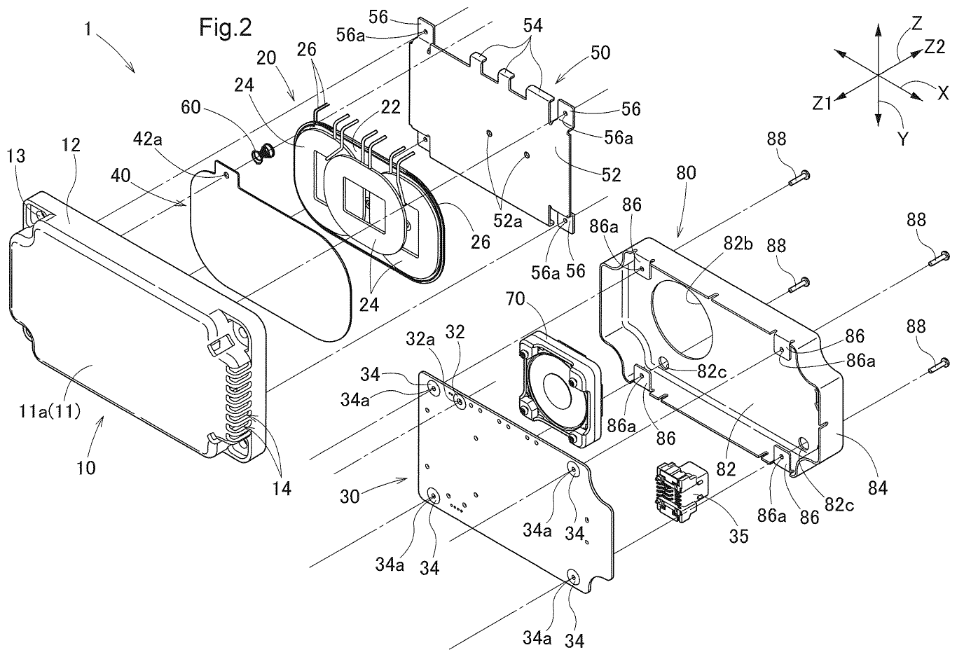

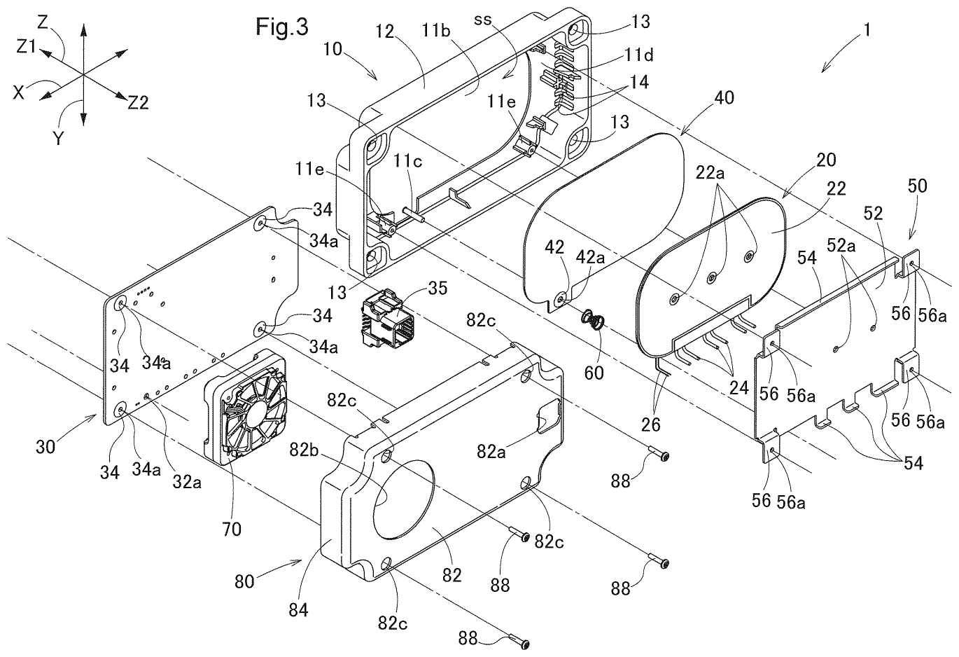

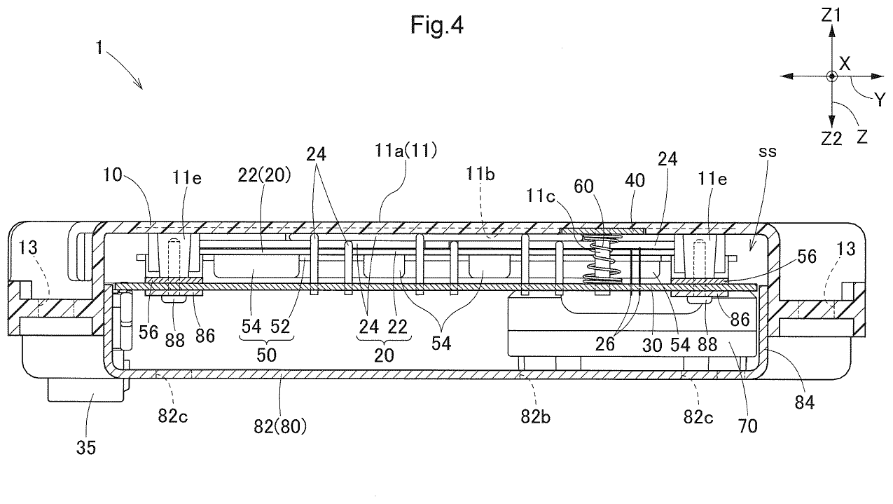

The present embodiment is a non-contact electric power supply device 1 for use to contactlessly charge a secondary battery such as a lithium-ion battery (not illustrated in the drawings) contained in a portable information terminal 5 (which is an example electric power supply target) such as a smartphone. The non-contact electric power supply device 1 is, as illustrated in FIG. 1, in the shape of a substantial rectangular parallelepiped. The non-contact electric power supply device 1 as the present embodiment, as illustrated in FIGS. 2 and 3, includes a cover 10, an electric power supply coil unit 20, a first substrate 30, a connector 35, a second substrate 40, a first shield casing 50, a compression coil spring 60 (which is an example connector element), a heat dissipating fan 70, and a casing 80.

As illustrated in FIG. 1, the cover 10 includes a placement section 11 with a placement face 11a. With a portable information terminal 5 on the placement face 11a, the non-contact electric power supply device 1 supplies electric power contactlessly to a secondary battery in the portable information terminal 5. Specifically, the electric power supply coil unit 20 includes two or more (three for the present embodiment) primary coils 24 (see FIG. 2). The non-contact electric power supply device 1 passes electric current through the primary coils 24 to generate respective magnetic fields, which in turn generate an induced electromotive force through a secondary coil (not illustrated in the drawings) in the portable information terminal 5 (electromagnetic induction). The induced electromotive force charges the secondary battery of the portable information terminal 5.

The description below uses the term “Z axis” to refer to an axis extending along the shortest sides (thickness) of the non-contact electric power supply device 1 (which is in the shape of a substantial rectangular parallelepiped) as shown in FIG. 1. The Z axis is, in other words, an axis along which the cover 10 is placed on the casing 80. The Z axis has a Z1 direction from the casing 80 to the cover 10 and a Z2 direction from the cover 10 to the casing 80. The description below uses the term “X axis” to refer to an axis extending along the long sides of the placement face 11a of the cover 10 (which is substantially rectangular) in a plan view, that is, as viewed in the Z2 direction, and the term “Y axis” to refer to an axis extending along the short sides of the placement face 11a in a plan view.

The cover 10 is in the form of a bottomed angular barrel made of an insulator such as resin. As illustrated in FIGS. 1 to 3, the cover 10 includes a placement section 11 substantially rectangular, visible in a plan view, and corresponding to the bottom of the angular barrel. The placement section 11 is in the form of a thin wall with an outer face serving as a placement face 11a on which to place a portable information terminal 5 as an electric power supply target. The cover 10 also includes a cover side wall 12 in the form of a thin wall arranged along the edge of the placement section 11 and extending in the Z2 direction from the four sides of the placement section 11. The cover side wall 12 has four dents in correspondence with the respective corners of the placement section 11 which dents are located toward the placement section 11. The cover 10 has four attachment through holes 13 in respective portions at the corners which portions are located away from the placement section 11. Inserting screws or the like through the respective attachment through holes 13 threadedly into a support wall or the like (not illustrated in the drawings) attaches the non-contact electric power supply device 1 to the support wall. The cover side wall 12 includes a section extending along one of the two short sides of the placement section 11 in a plan view and having two or more (ten for the present embodiment) air holes 14 that allow air to flow from inside the cover 10 to outside and vice versa.

As illustrated in FIG. 3, the placement section 11 has a back face 11d opposite to the placement face 11a. The back face 11d includes a fit-in section 11b facing in the Z1 direction and in the form of a depression configured to receive the second substrate 40. The fit-in section 11b is identical in shape to the second substrate 40 in a bottom view, that is, as viewed in the Z1 direction, so that the second substrate 40 fits closely in the fit-in section 11b. The fit-in section 11b may alternatively be larger than the second substrate 40, in which case the second substrate 40 fits in the fit-in section 11b in such a manner as to be at least partially in contact with or proximate to the fit-in section 11b. The fit-in section 11b has a depth slightly larger than the thickness of the second substrate 40, and may alternatively have a depth equal to or smaller than the thickness of the second substrate 40. The placement section 11 includes a support 11c in the form of a bar extending in the Z2 direction from the bottom face of the fit-in section 11b. The placement section 11 also includes two or more (four for the present embodiment) bosses 11e on the back face 11d and outward of the fit-in section 11b. The bosses 11e serve to position the first shield casing 50, the first substrate 30, and the casing 80 relative to the cover 10 along the Z axis. The bosses 11e threadedly receive respective fixing screws 88 for the first shield casing 50, the first substrate 30, and the casing 80 to be fixed to the cover 10. The bosses 11e are each in the form of a circular column with four outward ribs on its side surface and a hole as a bottomed hole.

The compression coil spring 60 is made of, for example, an electrically conductive metal and is, as illustrated in FIGS. 2 and 3, so shaped as to have at each end a diameter larger than the diameter at a central portion. The compression coil spring 60 has an equilibrium length larger than the distance between that face of the first substrate 30 which faces in the Z1 direction and that face of the second substrate 40 which faces in the Z2 direction. The compression coil spring 60 is elastically compressed between the first and second substrates 30 and 40 and is applying restoring force to the first and second substrates 30 and 40. The compression coil spring 60 may alternatively have a uniform diameter along its length, have at each end a diameter smaller than the diameter at a central portion, or taper from one end toward the other. The compression coil spring 60 may have any shape as long as the compression coil spring 60 is capable of applying a necessary restoring force (or contact force).

The first substrate 30 is in the form of a substantially rectangular plate with a short side curved inward at the opposite ends. The first substrate 30 is provided with electric circuits (not illustrated in the drawings) such as an electric power supply circuit, a charging circuit, and a control circuit for controlling how the non-contact electric power supply device 1 supplies electric power. The first substrate 30 is provided with a first land 32 (see FIG. 2) facing in the Z1 direction and connected to ground potential of the electric circuits for electric connection to the second substrate 40. The first land 32 is not covered by resist and has an exposed face of a copper foil optionally provided with metal plating. The first land 32 has a circular or annular outer shape. The first land 32 is in contact with a first end of the elastically deformed compression coil spring 60 and is receiving pressing force (or contact force) from the compression coil spring 60. The first land 32 has an outer diameter slightly larger than the outer diameter of each of the opposite ends of the compression coil spring 60 for reliable electric connection to the compression coil spring 60. The first land 32 has at its center a first through hole 32a with a diameter that allows passage of the support 11c of the cover 10. The first substrate 30 may be rigid or flexible, and may be a single-sided, double-sided, or multilayer substrate.

The connector 35 is on that face of the first substrate 30 which faces in the Z2 direction. The connector 35 receives a cable (not illustrated in the drawings) for connection thereto which cable serves to supply electric power from an external source to the non-contact electric power supply device 1. The casing 80 includes a second shield section 82 with a first opening 82a (through hole) corresponding in position to the connector 35 and allowing the connector 35 to protrude from the casing 80 in the Z2 direction (see FIG. 1). The connector 35 may alternatively not protrude from the casing 80 in the Z2 direction and may be exposed at the first opening 82a. The cable extends through the first opening 82a and is electrically connected to the connector 35. The first opening 82a may alternatively be open in a direction along the X axis, the Y axis, or an axis therebetween relative to the casing 80. In either of such cases, the connector 35 protrudes or is exposed in the direction in which the first opening 82a is open relative to the casing 80.

The heat dissipating fan 70 is attached to that face of the first substrate 30 which faces in the Z2 direction. The heat dissipating fan 70 serves to discharge hot air from the non-contact electric power supply device 1 to prevent the non-contact electric power supply device 1 from becoming at least partially heated. The hot air results from heat generated by electric current through the electric circuits on the first substrate 30 or the primary coils 24 (which is an example coil) of the electric power supply coil unit 20. The second shield section 82 has a second opening 82b (through hole) corresponding in position to where hot air is blown out of the heat dissipating fan 70 and allowing the heat dissipating fan 70 to be seen from outside the casing 80 (see FIG. 1). The heat dissipating fan 70 rotates to discharge hot air from the non-contact electric power supply device 1 through the second opening 82b or draw outside air into a container space ss (detailed later). The heat dissipating fan 70 may discharge hot air or draw in outside air through at least one of the above-mentioned air holes 14 in the cover 10 as well.

The first substrate 30 has a first face provided with four second lands 34 proximate to the respective corners and a second face provided with four other second lands 34 corresponding in position to the above second lands 34. The second lands 34 each have a circular or annular outer shape. The second lands 34 are not covered by resist and each have an exposed face of a copper foil optionally provided with metal plating (see FIGS. 2 and 3). The first substrate 30 is provided with second lands 34 in a number (eight for the present embodiment) twice the number of the fixing screws 88. The second lands 34 are connected to ground potential of the electric circuits. The second lands 34 each have at its center a first fixing through hole 34a, meaning that the first substrate 30 has four first fixing through holes 34a. The first fixing through holes 34a coincide with the respective holes in the bosses 11e of the cover 10 in a bottom view.

The electric power supply coil unit 20 includes a sheet 22, at least one (three for the present embodiment) primary coil 24, and a communication antenna 26. The sheet 22 is in the form of a rectangular plate made of a dielectric with magnetic absorbency and having rounded corners. The primary coils 24 are fixed to that face of the sheet 22 which faces in the Z1 direction. The communication antenna 26 is in the form of a coil extending along the edge of the sheet 22 and surrounding the primary coils 24. The sheet 22 has a surface area smaller than that of the first substrate 30, and is so sized as not to coincide with the first land 32 on the first substrate 30 in a plan view. While the first shield casing 50 includes a first shield section 52, the sheet 22 has a face facing in the Z2 direction and fixed to the first shield section 52 by means of adhesive, double-side tape, or the like. The sheet 22 controls magnetic fields generated by conduction of electric current through the primary coils 24 and improves the efficiency of supplying electric power to the portable information terminal 5.

Two of the three primary coils 24 are next to each other and in contact with that face of the sheet 22 which faces in the Z1 direction. The two primary coils 24 are bonded or otherwise fixed to the sheet 22. The remaining primary coil 24 is placed on and in contact with both the other two primary coils 24, and is bonded or otherwise fixed to the two primary coils 24. The sheet 22 has three first positioning holes 22a corresponding in position to the respective centers of the primary coils 24 (see FIG. 3). The communication antenna 26 is also bonded or otherwise fixed to the sheet 22. The primary coils 24 and the communication antenna 26 are not necessarily bonded to the sheet 22, and may alternatively be fixed thereto by means of double-side tape or the like.

The primary coils 24 and the communication antenna 26 each include a conducting line with an end soldered or otherwise electrically connected to the electric circuits on the first substrate 30. This allows the primary coils 24 and the communication antenna 26 to conduct electric current under control of the electric circuits. In response to conduction of electric current, the primary coils 24 generate respective magnetic fields, which in turn generate an induced electromotive force through a secondary coil (not illustrated in the drawings) in the portable information terminal 5. The induced electromotive force charges the secondary battery of the portable information terminal 5. The communication antenna 26 serves in wireless or contactless signal communication with the portable information terminal 5.

Placing a portable information terminal 5 on the placement face 11a causes the communication antenna 26 to wirelessly receive information on the portable information terminal 5. On the basis of the information, the electric circuits on the first substrate 30 start to pass electric current through the primary coils 24 to supply electric power to the portable information terminal 5. In response to the communication antenna 26 wirelessly receiving information indicating that the secondary battery of the portable information terminal 5 has been fully charged, the electric circuits stop passing electric current through the primary coils 24.

The electric power supply coil unit 20 for the present embodiment includes three primary coils 24. If the electric power supply coil unit 20 includes only one primary coil 24 at the center, the electric power supply coil unit 20 may include a magnet (not illustrated in the drawings) around the primary coil 24 or at its air core. In this case, the primary coil 24 and the magnet may be fixed to the sheet 22 by means of adhesive, double-side tape, or the like. This magnet and another magnet (not illustrated in the drawings) in the portable information terminal 5 attract each other for the portable information terminal 5 on the placement face 11a to be in position (magnetic alignment). This improves the efficiency of supplying electric power to the portable information terminal 5 contactlessly.

The second substrate 40 is in the form of a rectangular plate with rounded corners similarly to the sheet 22 and slightly larger than the sheet 22. The second substrate 40 is fixed to the fit-in section 11b of the cover 10 by means of adhesive, double-side tape, or the like. The second substrate 40 is provided with a noise attenuating pattern (not illustrated in the drawings) as an example circuit pattern for attenuating noise in respective magnetic fields generated by conduction of electric current through the primary coils 24. The noise attenuating pattern is, for example, a mesh pattern.

The second substrate 40 is provided with a third land 42 (see FIG. 3) facing in the Z2 direction and electrically connected to the noise attenuating pattern for electric connection to the first substrate 30. The third land 42 is not covered by resist and has an exposed face of a copper foil optionally provided with metal plating. The third land 42 has a circular or annular outer shape. The third land 42 is in contact with a second end of the elastically deformed compression coil spring 60 and is receiving pressing force (or contact force) from the compression coil spring 60. The third land 42 has an outer diameter slightly larger than the outer diameter of the second end of the compression coil spring 60 for reliable electric connection to the compression coil spring 60. The second substrate 40 may be rigid or flexible, and may be a single-sided, double-sided, or multilayer substrate.

The third land 42 has at its center a second through hole 42a with a diameter that allows passage of the support 11c of the cover 10. The support 11c extends through the second through hole 42a and the first through hole 32a with the compression coil spring 60 fitted around the support 11c. The compression coil spring 60 is supported by the support 11c while being restricted in terms to movement along the X and Y axes and positioned. This allows the first and third lands 32 and 42 to be electrically connected to each other more reliably. The compression coil spring 60 is so shaped as to have at a central portion a diameter smaller than the diameter at each end. The compression coil spring 60 is elastically deformed to apply contact force to the first land 32 on the first substrate 30 and the third land 42 on the second substrate 40 for electric connection between the first and third lands 32 and 42 with the compression coil spring 60 in-between. This causes the circuit pattern on the second substrate 40 to also have ground potential.

The first shield casing 50 is in the form of a bent plate having a substantially rectangular shape and made of a material with a good electromagnetic wave shielding property such as iron. The first shield casing 50 is located in the Z2 direction from the electric power supply coil unit 20 and in the Z1 direction from the first substrate 30. The first shield casing 50 is, in other words, between the sheet 22 of the electric power supply coil unit 20 and the first substrate 30. The first shield casing 50 may alternatively be made of an insulating material and have a surface provided with metal plating or coating.

The first shield casing 50 includes a first shield section 52 and first shield side walls 54. The first shield section 52 is in the form of a plate facing that face of the sheet 22 which faces in the Z2 direction. The first shield side walls 54 each extend at an angle from a long side of the first shield section 52 toward the first substrate 30, that is, in the Z2 direction. The first shield section 52 has two or more (two for the present embodiment) second positioning holes 52a to be positioned relative to the electric power supply coil unit 20 during the production of the non-contact electric power supply device 1.

The first shield section 52 has four corners each bent in the Z2 direction in the shape of a crank as a first bend 56 with an end extending parallel to the first shield section 52 and having a second fixing through hole 56a. The second fixing through holes 56a coincide with the respective holes in the bosses 11e of the cover 10 in a bottom view.

The casing 80 is opposite to the electric power supply coil unit 20 and the first shield casing 50 across the first substrate 30. The casing 80 is, similarly to the first shield casing 50, in the form of a bent plate made of a material with a good electromagnetic wave shielding property such as iron. The casing 80 has a shielding function. The casing 80 is, similarly to the cover 10, in the form of a bottomed angular barrel. The casing 80, as illustrated in FIGS. 1 to 3, includes a second shield section 82 in the form of a substantially rectangular plate and a second shield side wall 84 in the form of a thin wall arranged along the edge of the second shield section 82 and extending in the Z1 direction from the four sides of the second shield section 82. The second shield side wall 84, similarly to the cover 10, has four dents in correspondence with the respective corners of the second shield section 82. The dents allow the attachment through holes 13 to be seen in a bottom view, that is, in the Z1 direction from the casing 80. The casing 80 is not necessarily made of a material with a good electromagnetic wave shielding property, and may alternatively be made of an insulating material and have a surface provided with metal plating or coating. The casing 80 will be lightweight if made of an insulating material and strong if made of an electrically conductive metal material. The casing 80 will, if made of a metal material, have a higher thermal conductivity than the case of being made of resin, and serve to dissipate more of the heat generated by conduction of electric current through the electric circuits on the first substrate 30 and the primary coils 24 of the electric power supply coil unit 20. This further prevents the electric circuits and the primary coils 24 from becoming heated.

The second shield side wall 84 includes two or more (four for the present embodiment) second bends 86 each in the form of a bend at an end opposite to the second shield section 82 which bend is a 90-degree inward bend relative to the second shield side wall 84 (see FIG. 2). The second bends 86 have respective third fixing through holes 86a that coincide with the respective holes in the bosses 11e of the cover 10 in a bottom view. The second shield section 82 has four screw insertion openings 82c coinciding with the respective third fixing through holes 86a in a bottom view and having a diameter larger than the diameter of the third fixing through holes 86a. As described above, the second shield section 82 has a first opening 82a and a second opening 82b that allow the connector 35 and the heat dissipating fan 70, respectively, to be seen from outside.

As described above, the casing 80 is in the form of a bent plate made of a material with a good electromagnetic wave shielding property such as iron. The first substrate 30 is between the first shield casing 50 and the casing 80. Sandwiching the first substrate 30 between the first shield casing 50 and the casing 80 as above prevents the electric circuits on the first substrate 30 from being influenced by external noise, and also prevents the electric circuits from influencing its surrounding devices with extraneous emission, thereby ensuring electromagnetic compatibility.

Fixing the electric power supply coil unit 20 to the first shield casing 50, placing the first shield casing 50, the first substrate 30, and the casing 80 onto the bosses 11e of the cover 10, and screwing the fixing screws 88 into the respective bosses 11e fixes the first shield casing 50, the first substrate 30, and the casing 80 to the cover 10 and defines a container space ss between the cover 10 and the casing 80. The container space ss contains the second substrate 40, the electric power supply coil unit 20, the first shield casing 50, and the first substrate 30 each at least partially. The first bends 56 of the first shield casing 50 and the second bends 86 of the casing 80 are pressed against the respective second lands 34 on the first substrate 30. This causes the first shield casing 50 and the casing 80 to have ground potential.

### How to Produce Non-Contact Electric Power Supply Device

The description below deals with how to produce the non-contact electric power supply device 1. The non-contact electric power supply device 1 is not necessarily produced through the procedure below, and may be produced through any procedure as long as the non-contact electric power supply device 1 is produced appropriately.

A person fits the second substrate 40 into the fit-in section 11b on the back face 11d of the cover 10, and fixes the second substrate 40 to the cover 10 by means of adhesive, double-side tape, or the like. This inserts the support 11c of the cover 10 into the second through hole 42a in the second substrate 40.

The person positions the first shield casing 50 and the electric power supply coil unit 20 relative to each other with use of a jig or the like so that the second positioning holes 52a in the first shield casing 50 coincide with the respective first positioning holes 22a in the electric power supply coil unit 20 in a plan view. The person then fixes the electric power supply coil unit 20 to the first shield casing 50 by means of adhesive, double-side tape, or the like. The person also positions the first substrate 30 and the first shield casing 50 relative to each other with use of a jig or the like so that the first fixing through holes 34a in the first substrate 30 coincide with the respective second fixing through holes 56a in the first shield casing 50 in a plan view. While the three primary coils 24 of the electric power supply coil unit 20 and the communication antenna 26 each include a conducting line, the person solders or otherwise electrically connects an end of each conducting line to the electric circuits on the first substrate 30. This allows the primary coils 24 and the communication antenna 26 to conduct electric current, and integrates the electric power supply coil unit 20, the first shield casing 50, and the first substrate 30 with one another. The person attaches the connector 35 and the heat dissipating fan 70 to the first substrate 30 before or after the integration.

The person fits the compression coil spring 60 around the support 11c of the cover 10 (to which the second substrate 40 has been fixed). The person then places on the bosses 11e of the cover 10 the electric power supply coil unit 20, the first shield casing 50, and the first substrate 30 (which have been integrated with one another). The person also places the casing 80 over the above components. The person inserts the four fixing screws 88 in the Z1 direction through the respective screw insertion openings 82c and the respective third fixing through holes 86a in the casing 80, the respective first fixing through holes 34a in the first substrate 30, and the respective second fixing through holes 56a in the first shield casing 50 threadedly into the respective holes in the bosses 11e to join the casing 80 to the cover 10. This completes the non-contact electric power supply device 1. The cover 10 and the casing 80 as joined to each other defines therebetween a container space ss containing the second substrate 40, the electric power supply coil unit 20, the first shield casing 50, and the first substrate 30 each at least partially.

### How to Use Non-Contact Electric Power Supply Device

The user places a portable information terminal 5 on the placement face 11a of the cover 10. This causes the portable information terminal 5 to start communicating with the non-contact electric power supply device 1 through the communication antenna 26 and thereby causes the first substrate 30 to start passing electric current through the primary coils 24. If the portable information terminal 5 includes a magnet for magnetic alignment described above, this magnet and the magnet in the electric power supply coil unit 20 attract each other for the portable information terminal 5 on the placement face 11a to be at an optimum charging position. If the portable information terminal 5 does not include such a magnet, the non-contact electric power supply device 1 either (i) tries to locate the portable information terminal 5 while communicating with the portable information terminal 5 through the communication antenna 26 to check whether the non-contact electric power supply device 1 is able to charge the portable information terminal 5, or (ii) selects one of the primary coils 24 that will charge the portable information terminal 5 the most efficiently, to charge the portable information terminal 5. The non-contact electric power supply device 1 may include a structure for restricting the position of placement of a portable information terminal 5 for the portable information terminal 5 to be positioned relative to the primary coils 24 to be charged. Such a structure may alternatively be disposed in an area in which the non-contact electric power supply device 1 is disposed.

### How Non-Contact Electric Power Supply Device is Effective

The non-contact electric power supply device 1 as the present embodiment includes a compression coil spring 60 elastically deformed between the first and second substrates 30 and 40 and applying restoring force (contact force) to the first and second substrates 30 and 40. This allows the first and second substrates 30 and 40 to be electrically connected to each other easily. Fitting the compression coil spring 60 around the support 11c of the cover 10 allows the compression coil spring 60 to be positioned easily and prevents the compression coil spring 60 from becoming easily displaced due to its elastic deformation. This configuration allows a person to check whether the compression coil spring 60 is elastically deformed to determine whether the first and second substrates 30 and 40 are electrically connected to each other.

The non-contact electric power supply device 1 includes a second substrate 40 provided with a noise attenuating pattern for attenuating noise in respective magnetic fields generated by the primary coils 24 of the electric power supply coil unit 20. This reduces extraneous emission from the electric power supply coil unit 20 to prevent noise from affecting the portable information terminal 5 and surrounding devices. This in turn allows the non-contact electric power supply device 1 to have good electromagnetic interference characteristics.

The non-contact electric power supply device 1 includes a first shield casing 50 between the electric power supply coil unit 20 and the first substrate 30. The first shield casing 50 at least partially blocks the first substrate 30 to more efficiently block noise from the first substrate 30. This prevents such noise from overlapping respective magnetic fields generated by the primary coils 24 or affecting the portable information terminal 5 and surrounding devices.

The non-contact electric power supply device 1 includes a casing 80 with a shielding function. The casing 80 at least partially blocks that face of the first substrate 30 which is opposite to the electric power supply coil unit 20 to prevent noise from the first substrate 30 from adversely affecting surrounding devices. The casing 80 and the cover 10 define a container space ss therebetween for protecting the first substrate 30, the second substrate 40, and the electric power supply coil unit 20 from outside dust or the like.

The non-contact electric power supply device 1 includes a communication antenna 26 for contactless signal communication with the portable information terminal 5. This allows the non-contact electric power supply device 1 to start or stop supplying electric power to the portable information terminal 5 on the basis of the result of the communication.

### Alternative Embodiments

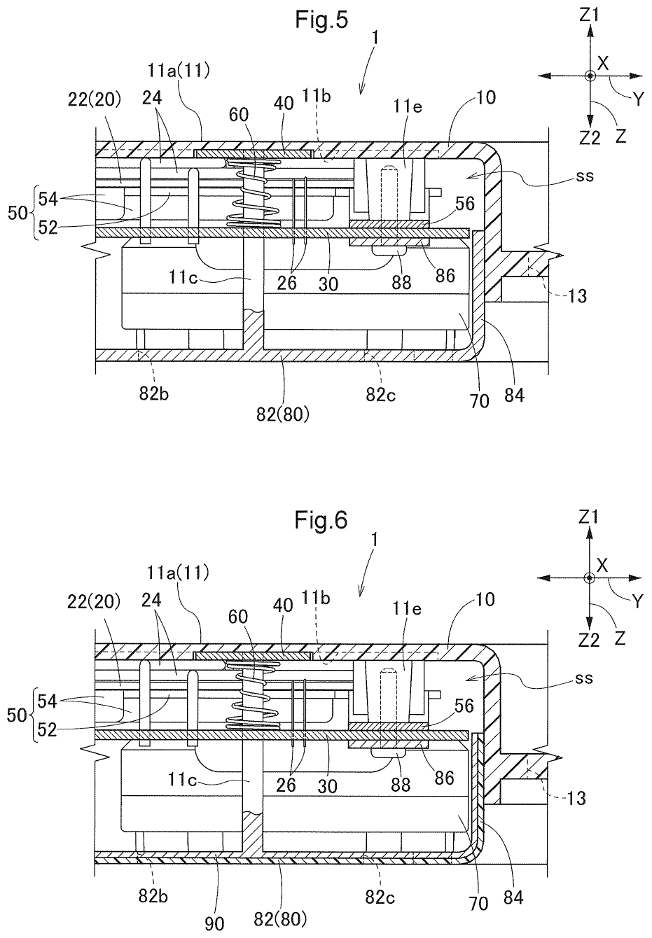

(1) The non-contact electric power supply device 1 as the above embodiment includes a support 11c (around which the compression coil spring 60 is fitted) extending through the second through hole 42a in the second substrate 40 and the first through hole 32a in the first substrate 30. This disclosure is, however, not limited to such a configuration. The support 11c may be so long as to extend through the second through hole 42a alone and not through the first through hole 32a, as long as the support 11c supports and positions the compression coil spring 60. In this case, the first substrate 30 may exclude the first through hole 32a.
(2) The non-contact electric power supply device 1 as the above embodiment includes a support 11c (around which the compression coil spring 60 is fitted) as part of the cover 10. This disclosure is, however, not limited to such a configuration. The support 11c may alternatively stand on the second shield section 82 of the casing 80 as illustrated in FIG. 5. In this case, the support 11c extends through the first through hole 32a in the first substrate 30 but may be not so long as to extend through the second through hole 42a in the second substrate 40. If the support 11c is not so long as to extend through the second through hole 42a, the second substrate 40 may exclude the second through hole 42a.
(3) The non-contact electric power supply device 1 as the above embodiment includes a casing 80 with a shielding function. The non-contact electric power supply device 1 may alternatively include a separate second shield casing 90 inside a casing 80 as illustrated in FIG. 6. The second shield casing 90 is made of a material with a good electromagnetic wave shielding property such as iron. The casing 80 may be made of resin or the like. The support 11c for this alternative embodiment may be provided for the second shield casing 90 (see FIG. 6) or for the casing 80 in such a manner as to extend through the second shield casing 90. The second shield casing 90 may alternatively be made of an insulating material and have a surface provided with metal plating or coating.
(4) The non-contact electric power supply device 1 as the above embodiment includes a compression coil spring 60 for electric connection between the first and second substrates 30 and 40. This disclosure is, however, not limited to such a configuration. The non-contact electric power supply device 1 may instead include a leaf spring for electric connection between the first and second substrates 30 and 40.
(5) The non-contact electric power supply device 1 as the above embodiment includes a first shield casing 50 and a casing 80 with a shielding function opposite to each other across the first substrate 30. The non-contact electric power supply device 1 may alternatively exclude either or both of the first shield casing 50 and the casing 80 if the non-contact electric power supply device 1 does not require electromagnetic compatibility to be ensured or if ensuring electromagnetic compatibility is not important. If the non-contact electric power supply device 1 excludes the first shield casing 50, the first substrate 30 may be provided with no second lands 34 on its face facing in the Z1 direction. If the non-contact electric power supply device 1 excludes the casing 80, the first substrate 30 may be provided with no second lands 34 on its face facing in the Z2 direction. If the non-contact electric power supply device 1 excludes the casing 80 with a shielding function, the non-contact electric power supply device 1 may instead include a casing 80 made of an insulating material and having no shielding function.

(6) The non-contact electric power supply device 1 as the above embodiment includes a cover 10 made of an insulating material such as resin. The cover 10 may alternatively be made of an electrically conductive metal material or an insulating material with a surface provided with metal plating or coating. The cover 10 will be lightweight if made of an insulating material and strong if made of an electrically conductive metal material.

(7) The non-contact electric power supply device 1 as the above embodiment includes air holes 14 and a heat dissipating fan 70 for discharging from the non-contact electric power supply device 1 heat generated by conduction of electric current through the electric circuits on the first substrate 30 or the primary coils 24 of the electric power supply coil unit 20. The non-contact electric power supply device 1 may alternatively exclude either or both of the air holes 14 and the heat dissipating fan 70 if such heat is generated in only small amounts. If such heat is generated in large amounts, the non-contact electric power supply device 1 may include two or more heat dissipating fans 70 and/or may include more air holes 14 as long as the increase in the number of air holes 14 does not decrease the strength of the cover 10. The casing 80 may, as well as the cover 10, include one or more air holes 14.

(8) The non-contact electric power supply device 1 as the above embodiment includes a first substrate 30 configured to receive electric power from an external device through the connector 35 and use the electric power to pass electric current through the electric power supply coil unit 20. This disclosure is, however, not limited to such a configuration. The non-contact electric power supply device 1 may, instead of receiving electric power from an external device, contain a battery for passing electric current through the electric power supply coil unit 20. In this case, the non-contact electric power supply device 1 may exclude the connector 35 or use the connector 35 to communicate with an external device for the external device to control the non-contact electric power supply device 1. The non-contact electric power supply device 1 may exclude the connector 35 and be provided with a cable soldered or otherwise connected directly to the first substrate 30.

The above battery may be a primary or secondary battery. The battery may be configured to at least either generate electric power or receive electric power from an external device contactlessly and to use the electric power to pass electric current through the electric power supply coil unit 20. The generation of electric power is, for example, photogeneration, thermogeneration, or ambient generation that utilizes kinetic energy of vibration or the like. The battery allows the user to carry the non-contact electric power supply device 1 and charge a portable information terminal 5 without an external power source.

(9) The non-contact electric power supply device 1 as the above embodiment includes an electric power supply coil unit 20 with three primary coils 24. The electric power supply coil unit 20 may alternatively include one or two primary coils 24 or four or more primary coils 24.

(10) The non-contact electric power supply device 1 as the above embodiment includes a second substrate 40 provided with a noise attenuating pattern for attenuating noise in respective magnetic fields generated by conduction of electric current through the primary coils 24. This disclosure is, however, not limited to such a configuration. The second substrate 40 may be provided with an additional circuit pattern for controlling a property of the primary coils 24. The second substrate 40 may be provided with an electronic component in addition to a circuit pattern. The second substrate 40 is not necessarily fitted in the fit-in section 11b of the cover 10. Specifically, the non-contact electric power supply device 1 may alternatively be configured such that the cover 10 does not include a fit-in section 11b on its back face 11d and that the second substrate 40 is directly fixed to the back face 11d.

(11) The non-contact electric power supply device 1 as the above embodiment includes a second substrate 40 fixed to the cover 10. The second substrate 40 may alternatively be fixed to the electric power supply coil unit 20.

(12) The non-contact electric power supply device 1 as the above embodiment includes a communication antenna 26 fixed to the sheet 22 of the electric power supply coil unit 20. The communication antenna 26 may alternatively be supported by the primary coils 24 or the first substrate 30. The communication antenna 26 may be supported by the first shield casing 50 and electrically insulated therefrom. If the communication antenna 26 is supported by the first substrate 30, the communication antenna 26 should be at least partially exposed from the first shield casing 50 in a plan view.

(13) The communication antenna 26 may be fixed to the second substrate 40. The communication antenna 26 may be in the form of a pattern on the second substrate 40. If the communication antenna 26 is on the second substrate 40, the non-contact electric power supply device 1 should desirably include, for signal communication with the first substrate 30 through the communication antenna 26, a compression coil spring for signal communication which compression coil spring is separate from the compression coil spring 60 (which has ground potential) and has a potential other than ground potential.

(14) The non-contact electric power supply device 1 as the above embodiment may be altered such that the cover 10 is integral with a device or equipment on which the non-contact electric power supply device 1 is disposed. In this case, the second substrate 40, the electric power supply coil unit 20, the first shield casing 50, and the first substrate 30 (which are contained at least partially in the container space ss) may be supported by and fixed to the casing 80.

1. A non-contact electric power supply device for supplying electric power contactlessly to an electric power supply target including a secondary battery,
the non-contact electric power supply device comprising:
a cover with a placement face on which to place the electric power supply target;
a casing joined to the cover and defining a container space together with the cover;
an electric power supply coil unit contained at least partially in the container space, oriented parallel to the placement face, and including a coil configured to, in response to receiving electric power, generate a magnetic field for supplying electric power to the electric power supply target on the placement face;
a first substrate contained at least partially in the container space, disposed opposite to the placement face across the electric power supply coil unit, and configured to supply electric power to the coil;
a second substrate contained at least partially in the container space, disposed between the placement face and the electric power supply coil unit, and configured to attenuate noise in the magnetic field; and
an elastic connector element disposed between the first substrate and the second substrate and electrically connecting the first substrate to the second substrate.

2. The non-contact electric power supply device according to claim 1, wherein
the cover includes a support in a form of a bar extending perpendicularly to a face of the second substrate through the second substrate, and
the connector element is a compression coil spring fitted around the support and elastically deformed between the first substrate and the second substrate to electrically connect the first substrate to the second substrate.

3. The non-contact electric power supply device according to claim 1, further comprising:
a first shield casing contained at least partially in the container space and disposed between the electric power supply coil unit and the first substrate.

4. The non-contact electric power supply device according to claim 2, further comprising:
a first shield casing contained at least partially in the container space and disposed between the electric power supply coil unit and the first substrate.

5. The non-contact electric power supply device according to claim 1, further comprising:
a second shield casing disposed opposite to the electric power supply coil unit across the first substrate.

6. The non-contact electric power supply device according to claim 2, further comprising:
a second shield casing disposed opposite to the electric power supply coil unit across the first substrate.

7. The non-contact electric power supply device according to claim 3, further comprising:
a second shield casing disposed opposite to the electric power supply coil unit across the first substrate.

8. The non-contact electric power supply device according to claim 4, further comprising:
a second shield casing disposed opposite to the electric power supply coil unit across the first substrate.

9. The non-contact electric power supply device according to claim 5, wherein
the second shield casing includes a support in a form of a bar extending perpendicularly to a face of the first substrate through the first substrate, and
the connector element is a compression coil spring fitted around the support and elastically deformed between the first substrate and the second substrate to electrically connect the first substrate to the second substrate.

10. The non-contact electric power supply device according to claim 7, wherein
the second shield casing includes a support in a form of a bar extending perpendicularly to a face of the first substrate through the first substrate, and
the connector element is a compression coil spring fitted around the support and elastically deformed between the first substrate and the second substrate to electrically connect the first substrate to the second substrate.

11. The non-contact electric power supply device according to claim 1, wherein
the casing has a shielding function.

12. The non-contact electric power supply device according to claim 2, wherein
the casing has a shielding function.

13. The non-contact electric power supply device according to claim 3, wherein
the casing has a shielding function.

14. The non-contact electric power supply device according to claim 4, wherein
the casing has a shielding function.

15. The non-contact electric power supply device according to claim 11, wherein
the casing includes a support in a form of a bar extending perpendicularly to a face of the first substrate through the first substrate, and
the connector element is a compression coil spring fitted around the support and elastically deformed between the first substrate and the second substrate to electrically connect the first substrate to the second substrate.

16. The non-contact electric power supply device according to claim 13, wherein
the casing includes a support in a form of a bar extending perpendicularly to a face of the first substrate through the first substrate, and
the connector element is a compression coil spring fitted around the support and elastically deformed between the first substrate and the second substrate to electrically connect the first substrate to the second substrate.

17. The non-contact electric power supply device according to claim 1, further comprising:
a communication antenna for contactless signal communication with the electric power supply target.

18. The non-contact electric power supply device according to claim 2, further comprising:
a communication antenna for contactless signal communication with the electric power supply target.

19. The non-contact electric power supply device according to claim 3, further comprising:
a communication antenna for contactless signal communication with the electric power supply target.

20. The non-contact electric power supply device according to claim 5, further comprising:
a communication antenna for contactless signal communication with the electric power supply target.
